(19) United States
(12) Patent Application Publication
(10) Pub. No.: US 2013/0259781 A1
(43) Pub. Date: Oct. 3, 2013

(54) FLUE GAS TREATMENT SYSTEM WITH AMMONIA SOLVENT FOR CAPTURE OF CARBON DIOXIDE

(71) Applicant: ALSTOM TECHNOLOGY LTD., Baden (CH)

(72) Inventors: Frederic Vitse, Knoxville, TN (US); Geert Versteeg, Enschede (NL)

(73) Assignee: ALSTOM TECHNOLOGY LTD, Baden (CH)

(21) Appl. No.: 13/832,478

(22) Filed: Mar. 15, 2013

Related U.S. Application Data
(60) Provisional application No. 61/617,879, filed on Mar. 30, 2012.

(51) Int. Cl. B01D 53/62; B01D 53/14

(52) U.S. Cl. CPC B01D 53/62; B01D 53/1425
USPC 423/220; 422/173; 96/242

(57) ABSTRACT

A system for treating a flue gas from a combustion process comprises an absorber vessel configured to receive an aqueous ammonia solvent stream lean in CO₂ and a flue gas stream having CO₂, the aqueous ammonia solvent stream and the flue gas stream in contact in the absorber vessel in a counter-current arrangement to provide an outlet stream rich in CO₂; a desorber configured to strip the CO₂ from the outlet stream rich in CO₂ from the absorber vessel at a temperature less than 100 degrees C. and to return the resultant aqueous ammonia solvent stream lean in CO₂ to the absorber vessel; a source of heat configured to supply heat to the desorber; and a CO₂ sequestration system for sequestering CO₂ stripped by the desorber.

### CROSS-REFERENCE TO RELATED APPLICATION

This patent application claims benefit under 35 U.S.C. §119(e) of co-pending U.S. Provisional Patent Application No. 61/617,879 entitled “FLUE GAS TREATMENT SYSTEM WITH AMMONIA SOLVENT FOR CAPTURE OF CARBON DIOXIDE,” filed Mar. 30, 2012, the disclosure of which is incorporated by reference herein in its entirety.

### TECHNICAL FIELD

The present disclosure generally relates to a treatment system that utilizes an ammonia solvent for the capture of carbon dioxide (CO₂) from a flue gas and more particularly relates to a flue gas treatment system that absorbs CO₂ into an ammonia solvent and regenerates the CO₂ at low pressure and temperature.

### BACKGROUND

The combustion of carbon- and hydrogen-containing fuel such as oil, coal, and natural gas generally results in the production of a flue gas stream containing contaminant emissions in the form of particulates, hydrocarbons, SOₓ, NOₓ, and the like. Awareness regarding the effects of these contaminants on the environment has generally called for the enforcement of stringent limits on emissions thereof into the atmosphere. As such, those that combust such fuels must find more efficient ways to remove contaminants before venting the flue gas stream to the atmosphere.

One particular environmental contaminant is CO₂, which is typically referred to as a “greenhouse gas.” Although CO₂ is considered an atmospheric contaminant, it has various beneficial uses, and so it is often absorbed from flue gas into a solvent, regenerated from the solvent, captured, and compressed for use. The efficient capture of CO₂ by such a process requires a balancing of the energy requirements for the actual regeneration of the CO₂ from the solvent against the energy requirements for the compression of the CO₂. Regeneration of the CO₂ at relatively high pressures and temperatures using steam to desorb or strip the solvent from the CO₂ reduces the electric power requirements for compression but detrimentally affects the stability of the solvent in which the CO₂ is entrained. Conversely, regeneration of the CO₂ at relatively low pressure and temperature increases the energy needed for compression of the CO₂. Thus, the selection of a suitable pressure for the regeneration of the CO₂ using steam stripping in a power plant is generally dictated by the steam cycle in the plant and the quality of the steam at the point at which steam is extracted from the steam cycle. For most absorption/desorption schemes utilizing steam stripping, the steam quality is constrained by the production of water vapor to achieve stripping of the CO₂ from the solvent. This means that when the regeneration is carried out at atmospheric pressure, the steam extraction of the CO₂ takes place at temperatures above 100 degrees C.

### SUMMARY

According to one aspect disclosed herein, a system for treating a flue gas from a combustion process comprises an absorber vessel configured to receive an aqueous ammonia solvent stream lean in CO₂ and a flue gas stream having CO₂, the aqueous ammonia solvent stream and the flue gas stream contacting in the absorber vessel in a counter-current arrangement to provide an outlet solvent stream rich in CO₂. The system also comprises a desorber configured to strip the CO₂ from the outlet solvent stream rich in CO₂ produced in the absorber vessel at a temperature less than 100 degrees C. and return the resultant aqueous ammonia solvent stream lean in CO₂ to the absorber vessel. The system further comprises a source of heat configured to supply heat to the desorber and a CO₂ sequestration system for sequestering CO₂ stripped from the outlet solvent stream rich in CO₂ in the desorber.

According to other aspects disclosed herein, a CO₂ capture system comprises a packed column comprising a vessel and a packing material therein, the packed column configured to receive an aqueous ammonia solvent stream lean in CO₂ at an upper portion thereof and a flue gas stream having CO₂ at a lower portion thereof, the aqueous ammonia solvent stream and the flue gas stream being in contact in the packed column in a counter-current arrangement to provide an outlet solvent stream rich in CO₂. The system also comprises a desorber configured to strip the CO₂ from the outlet solvent stream rich in CO₂ produced in the packed column at a temperature less than 100 degrees C. and return the resultant aqueous ammonia solvent stream lean in CO₂ to the upper portion of the packed column. A source of heat is configured to supply heat to the desorber.

According to still other aspects disclosed herein, a method for removing CO₂ from a flue gas stream comprises the steps of contacting an aqueous ammonia solvent stream lean in CO₂ with a flue gas stream having CO₂, the aqueous ammonia solvent stream and the flue gas stream being in contact in the absorber vessel in a counter-current arrangement. An outlet stream is directed from the absorber vessel to a desorber, the outlet stream being rich in CO₂ absorbed from the flue gas. The desorber is heated using a source of heat, and the CO₂ is stripped from the outlet stream rich in CO₂ at a temperature less than 100 degrees C. to remove at least a portion of the CO₂ therefrom to produce the aqueous ammonia solvent stream lean in CO₂. The method also includes the steps of sequestering the CO₂ stripped from the outlet stream rich in CO₂ and returning the resultant aqueous ammonia solvent stream lean in CO₂ to the absorber vessel.

The above described and other features are exemplified by the following Figures and detailed description.

### BRIEF DESCRIPTION OF THE DRAWINGS

Referring now to the Figures, which are exemplary embodiments, and wherein the like elements are numbered alike:

FIG. 1 is a schematic representation of a flue gas processing system for the capture of CO₂; and

FIG. 2 is a schematic representation of a CO₂ capture system and heat transfer system of the flue gas processing system of FIG. 1.

### DETAILED DESCRIPTION

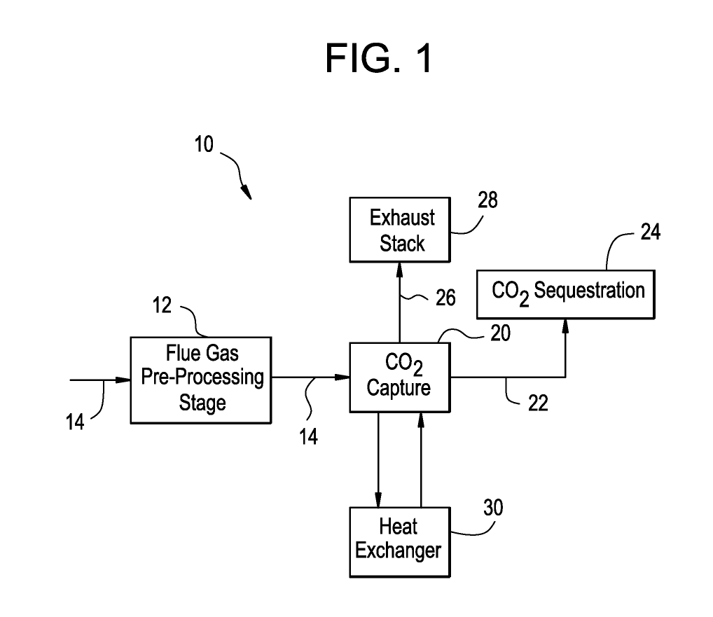

As illustrated in FIG. 1, a system for treating a flue gas containing CO₂ by the capture of CO₂ from the flue gas is designated generally by the reference number 10 and is hereinafter referred to as “system 10.” In system 10, CO₂ is captured from a flue gas containing CO₂ by absorption utilizing a solvent, and then removed from the solvent at relatively low temperatures utilizing waste heat, e.g., heat from a power generation plant, heat from solar energy, or heat from geothermal energy. The solvent is selected such that the capture and sequestration of the CO₂ takes place at relatively low pressure. By using heat from various sources such as waste heat, a solvent having relatively low volatility, and a relatively low system pressure, the use of a steam cycle (such as for example, that of a power generation plant utilizing system 10) to remove CO₂ from the solvent may be avoided. In system 10, the volatility and system pressure are low as compared to similar systems for treating flue gas containing CO₂.

The system 10 includes a flue gas pre-processing stage 12 that receives a flue gas stream 14 from a boiler, a furnace, or the like. The flue gas stream 14 contains CO₂. The flue gas pre-processing stage 12 may include one or more devices such as, but not limited to, a scrubber, a dust removal system, a pre-heater, or the like. From the flue gas pre-processing stage 12, the flue gas stream 14 is directed to a CO₂ capture system 20 that utilizes an aqueous ammonia solvent that allows for CO₂ capture from the flue gas stream 14 and CO₂ stripping from the aqueous ammonia solvent for CO₂ regeneration. Once a desired portion of the CO₂ is regenerated (as CO₂ stream 22), the regenerated CO₂ is sequestered in a CO₂ sequestration apparatus 24. Upon capture of CO₂ from flue gas stream 14, a treated flue gas stream 26 is produced and conveyed to an exhaust stack 28. The CO₂ capture system 20 is in fluid communication with a heat transfer system 30 that allows for heat transfer between the aqueous ammonia solvent streams flowing to and from the CO₂ capture system 20. The various components of system 10, such as the flue gas pre-processing stage 12, the CO₂ capture system 20, the exhaust stack 28, the heat transfer system 30, and the CO₂ sequestration apparatus 24, are fluidly connected.

The aqueous ammonia solvent is an ionic ammonia solution that is about 10 weight percent (wt. %) ammonia based on ammonium carbonates, ammonium bicarbonates, and/or ammonium carbamates.

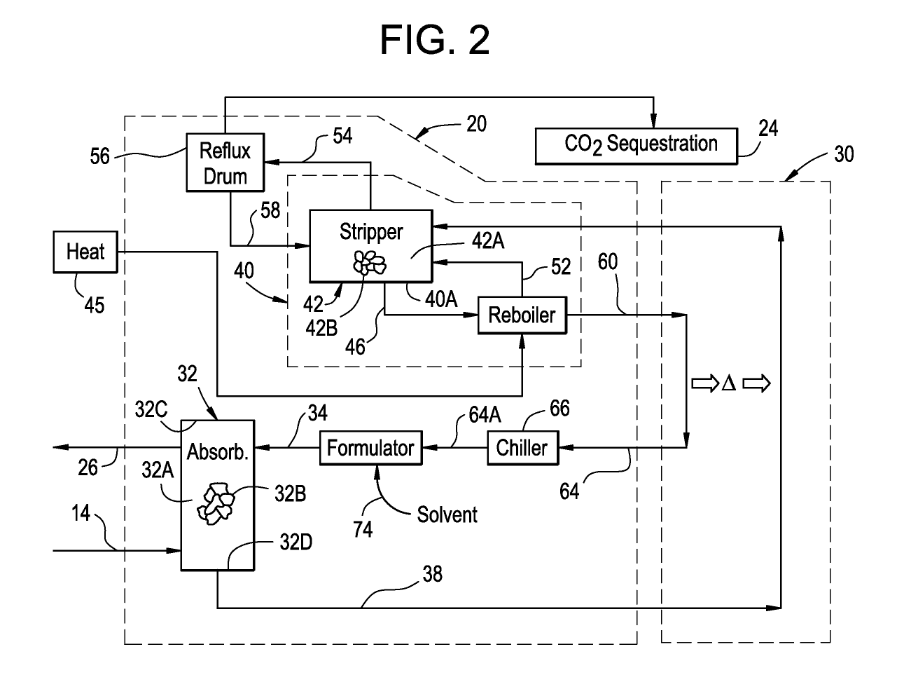

As illustrated in FIG. 2, the CO₂ capture system 20 includes an absorber vessel 32 in which the aqueous ammonia solvent contacts the flue gas stream 14. The absorber vessel 32 is a packed column with an interior area 32A containing packing material 32B either arranged in a structured configuration or randomly dumped within interior area 32A of the absorber vessel 32. In contacting the aqueous ammonia solution with the flue gas stream 14, the same are mixed in a counter-current arrangement within absorber vessel 32. In particular, the aqueous ammonia stream flowing into the absorber vessel 32, which is hereinafter referred to as the absorber inlet stream 34, is received by the absorber vessel 32 and is distributed within the upper portion or top 32C of the absorber vessel 32 via a liquid distribution system (not shown). The flue gas stream 14 is introduced to the absorber vessel 32 at or near the bottom 32D thereof. Because the aqueous ammonia solvent is introduced at or near the top 32C of the absorber vessel 32 using the liquid distribution system, the aqueous ammonia solvent is substantially evenly distributed over the complete horizontal cross-section of the interior area 32A of absorber vessel 32, thereby allowing the aqueous ammonia solvent to permeate the packing material 32B and flow downwardly in a substantially even manner contacting the flue gas stream 14 flowing upwardly through the packing material 32B and interior area 32A.

The absorber inlet stream 34 is rich in ammonia and lean in CO₂, which allows it to absorb CO₂ from the flue gas stream 14. Absorbing CO₂ from the flue gas stream 14 increases the concentration of CO₂ in the aqueous ammonia solvent and thus renders it “rich in CO₂.” Once discharged from the absorber vessel 32, the aqueous ammonia solvent rich in CO₂, hereinafter referred to as the absorber outlet stream 38, is directed to the heat transfer system 30.

The heat transfer system 30 is a heat exchanger. The heat exchanger may be, but is not limited to, a plate-and-frame design. In the heat exchanger, the absorber outlet stream 38 is heated and directed to a desorber 40, which strips the CO₂ from the absorber outlet stream 38 to regenerate the CO₂ and the aqueous ammonia solvent lean in CO₂.

Still referring to FIG. 2, the desorber 40 includes a vessel 42 and a reboiler 50 that provides heat to the vessel 42. The vessel 42 is any suitable container with a hollow interior area 42A, for example, a generally hollow cylindrically-shaped column having gas-liquid contacting devices 42B suitable for facilitating mass transfer. Such gas-liquid contacting devices 42B include, but are not limited to, random packing material, structured packing material, and trays. The reboiler 50 receives a takeoff stream 46 comprising aqueous ammonia solvent substantially free of CO₂ from the bottom 40A of the desorber 40, heats the takeoff stream 46, and returns a heated return stream 52 to the desorber 40.

Because the system 10 utilizes aqueous ammonia solvent that vaporizes at a temperature lower than that for water at any given pressure, the reboiler 50 operates upon receiving heat from a heat source 45, which can comprise any suitable source of heat, including waste heat from a plant process. The heat source 45 is not limited to waste heat from a plant process, but rather the heat may result from any source including, but not limited to, a plant steam cycle, a geothermal source, or solar heat. In so heating the reboiler 50, the desorber 40 operates at atmospheric pressure to strip ammonia at a temperature below that of the boiling point of water (less than 100 degrees C.), such that ammonia is effectively vaporized from the heated absorber outlet stream 38 (the CO₂-rich aqueous ammonia solvent) and subsequently condensed in either the packing material 42B or on the trays 42B of the desorber 40, thereby regenerating the CO₂.

After condensing the ammonia from the CO₂-rich aqueous ammonia solvent in the desorber 40, an overhead CO₂ stream 54 is taken from the top 40A of the desorber 40 and directed to a reflux drum 56. Because the overhead CO₂ stream 54 contains some amount of ammonia vapor, the reflux drum 56 allows the ammonia vapors to condense and be returned to the upper portion or top 40A of the desorber 40 via an overhead return stream 58.

From the reflux drum 56, CO₂ is removed and sequestered in the CO₂ sequestration apparatus 24. Any suitable method of sequestering the CO₂ may be used. For example, the CO₂ may be reacted with a metal oxide to produce a carbonate, which may be stored as a solid.

From the reboiler 50, an ammonia solvent takeoff stream 60 is directed back to the heat transfer system 30. The ammonia solvent takeoff stream 60 is substantially free of CO₂ and is close to the boiling point of the aqueous ammonia solvent. The heat transfer system 30 is configured such that upon receiving the ammonia solvent takeoff stream 60, heat is transferred from the ammonia solvent takeoff stream 60 to the absorber outlet stream 38, thus cooling the ammonia solvent takeoff stream 60 and heating the absorber outlet stream 38 flowing to the desorber 40.

The cooled ammonia solvent takeoff stream (hereinafter designated by the reference number 64, flows from the heat transfer system 30 to a chiller 66, which further cools the ammonia solvent 64 to produce chilled solvent 64A. The chilled solvent 64A is analyzed using a formulator 70 or any other suitable apparatus to determine the amount (e.g., mole ratio) of CO₂. The formulator 70 may also adjust the composition of the chilled solvent 64A by (optionally) adding makeup aqueous ammonia solvent 74 calculated to have a particular molar concentration to render the chilled solvent 64A from the formulator 70 (which corresponds to the absorber inlet stream 34) of a desired concentration of ammonia for use in the absorber vessel 32.

By controlling the operating temperature of the absorber vessel 32, the operating pressure of the desorber 40, the molar concentration of the aqueous ammonia solvent (e.g., by adjusting the operating temperature and flow rates of the solvent through the reboiler 50), solvent and flue gas flow rates, and the amount of makeup aqueous ammonia solvent 74 added in the formulator 70, the system 10 can be operated using waste heat, heat from solar sources, heat from geothermal sources, or other thermal sources. Furthermore, the system 10 can be advantageously operated with the reboiler 50 and/or the desorber 40 at ambient pressure and a temperature of less than about 100 degrees C. under a lean loading of less than about 0.332 mole/mole. Also, the capture of CO₂ at relatively low temperatures can be adjusted to obtain a desired amount of CO₂ at the sequestration apparatus 24.

### EXAMPLE

Using the CO₂ capture system 20, several different processes of capturing CO₂ were simulated to demonstrate the impact of CO₂ regeneration pressure on the overall process performance. In such simulations, the reboiler 50 was operated at pressures ranging from 10 bar down to 1 bar, and analyses were made at various pressures to determine effective CO₂ capture rates. The desorber 40 was heated solely through the reboiler 50. The aqueous ammonia solvent contained about 10 wt. % ammonia, and the solvent temperature at the inlet of the absorber (absorber inlet stream 34) was about 5 degrees C.

TABLE
Process conditions for different reboiler pressures.

| | | | des | abs | total | CO2 |
|---|---|---|---|---|---|---|
| Preboiler | lean loading | Treb | NH3out | NH3out | NH3out | capture |
| [bar] | [mole/mole] | [° C.] | [kg/s] | [kg/s] | [kg/s] | [—] |
| 10 | 0.251 | 136.8 | 1.13 | 10.96 | 12.09 | 0.916 |
| 7 | 0.258 | 127.2 | 1.44 | 10.67 | 12.11 | 0.908 |
| 5 | 0.266 | 118.3 | 1.74 | 10.41 | 12.15 | 0.899 |
| 4 | 0.269 | 112.6 | 1.96 | 10.32 | 12.29 | 0.896 |
| 3 | 0.275 | 105.2 | 2.23 | 10.08 | 12.31 | 0.889 |
| 2 | 0.281 | 95.0 | 2.63 | 9.89 | 12.52 | 0.883 |
| 1.5 | 0.292 | 87.8 | 3.01 | 9.41 | 12.42 | 0.876 |
| 1.3 | 0.307 | 84.7 | 3.38 | 8.81 | 12.20 | 0.847 |
| 1.1 | 0.323 | 80.0 | 3.87 | 8.07 | 11.94 | 0.823 |
| 1 | 0.332 | 77.7 | 4.14 | 7.68 | 11.82 | 0.810 |

Because the aqueous ammonia solvent is of -high volatility as compared to water, the amount of heat needed to raise the solvent to a suitable temperature for stripping of the CO₂ therefrom is less than the amount needed to raise water to a suitable temperature for stripping of the CO₂.

As seen in the above Table, acceptable capture rates of CO₂ above 80% were achieved from the desorber 40 with reboiler temperatures as low as about 78 degrees C. In particular, at atmospheric pressure, a CO₂ capture rate of 81.0% was desirably achieved at 77.7 degrees C. Also, the amount of ammonia exiting the CO₂ capture system 20 remains substantially unchanged for a marked decrease in reboiler temperature and pressure, while the bulk of the emissions has shifted from the absorber vessel 32 to the overhead CO₂ stream 54 due to the lean loading of the solvent. This is advantageous as the cycling of the aqueous ammonia solvent throughout the system 10 is favored by the conditions in the desorber 40, such as the lower volumetric flow rates of gas. Furthermore, it is contemplated that the use of a heat source other than waste heat to heat the reboiler 50 will result in a substantial increase in energy input without returning a corresponding increase in output in the form of CO₂ captured.

While the invention has been disclosed and described with respect to the detailed embodiments hereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the foregoing description.

What is claimed is:

1. A system for treating a flue gas from a combustion process, the system comprising:
an absorber vessel configured to receive an aqueous ammonia solvent stream lean in CO₂ and a flue gas stream having CO₂, the aqueous ammonia solvent stream and the flue gas stream in contact in the absorber vessel in a counter-current arrangement to provide an outlet stream rich in CO₂;
a desorber configured to strip the CO₂ from the outlet stream rich in CO₂ at a temperature approximately less than 100 degrees C. to produce stripped CO₂ and to produce an aqueous ammonia solvent stream lean in CO₂ for return to the absorber vessel;
a source of heat configured to supply heat to the desorber; and
a CO₂ sequestration system for sequestering stripped CO₂.

2. The system of claim 1, further comprising a heat exchanger between the absorber vessel and the desorber, the heat exchanger configured to transfer heat from the aqueous ammonia solvent stream lean in CO₂ from the desorber to the outlet stream rich in CO₂ from the absorber vessel.

3. The system of claim 1, further comprising a chiller configured to cool the aqueous ammonia solvent stream lean in CO₂ from the desorber for return to the absorber vessel.

4. The system of claim 1, further comprising a formulator configured to receive and adjust the composition of the aqueous ammonia solvent stream lean in CO₂ from the desorber for return to the absorber vessel.

5. The system of claim 1, wherein the desorber comprises a reboiler operable at pressures of about 1 bar to about 10 bar.

6. The system of claim 5, wherein an operating temperature of the reboiler is about 78 degrees C. to about 136 degrees C.

7. The system of claim 6, wherein the ammonia solvent stream comprises about 10 wt. % ammonia.

8. A CO₂ capture system, comprising:
a packed column configured to receive an aqueous ammonia solvent stream lean in CO₂ at a top thereof and a flue gas stream having CO₂ at a bottom thereof, the aqueous ammonia solvent stream and the flue gas stream in contact in the packed column in a counter-current arrangement to provide an outlet stream of ammonia solvent rich in CO₂;
a desorber configured to strip the CO₂ from the outlet stream rich in CO₂ at a temperature of less than approximately 100 degrees C. to produce stripped CO2 and to produce an aqueous ammonia solvent stream lean in CO₂; and
a source of heat configured to supply heat to the desorber.

9. The CO₂ capture system of claim 8, further comprising a heat exchanger between the packed column and the desorber, the heat exchanger configured to transfer heat from the aqueous ammonia solvent stream lean in CO₂ from the desorber to the outlet stream rich in CO₂ from the packed column.

10. The CO₂ capture system of claim 8, wherein the desorber comprises a reboiler operable at pressures of about 1 bar to about 10 bar.

11. The CO₂ capture system of claim 10, wherein an operating temperature of the reboiler is about 78 degrees C. to about 136 degrees C.

12. The CO₂ capture system of claim 10, wherein the ammonia solvent stream comprises about 10 wt. % ammonia based on at least one of ammonium carbonates, ammonium bicarbonates, and ammonium carbamates.

13. A method for removing CO₂ from a flue gas stream, comprising:
contacting an aqueous ammonia solvent stream lean in CO₂ with a flue gas stream having CO₂, the aqueous ammonia solvent stream and the flue gas stream in contact in an absorber vessel in a counter-current arrangement;
directing an outlet stream from the absorber vessel to a desorber, the outlet stream being rich in CO₂ absorbed from the flue gas;
heating the desorber;
stripping the CO₂ from the outlet stream rich in CO₂ at a temperature of less than 100 degrees C. to remove at least a portion of the CO₂ and producing the aqueous ammonia solvent stream lean in CO₂;
sequestering the CO₂ stripped from the outlet stream rich in CO₂; and
returning the aqueous ammonia solvent stream lean in CO₂ to the absorber vessel.

14. The method of claim 13, further comprising transferring heat from the aqueous ammonia solvent stream lean in CO₂ returned to the absorber vessel from the desorber to the outlet stream from the absorber vessel to a desorber.

15. The method of claim 13, further comprising cooling the aqueous ammonia solvent stream lean in CO₂ from the desorber to the absorber vessel.

16. The method of claim 13, further comprising adjusting a composition of the aqueous ammonia solvent stream lean in CO₂ from the desorber to the absorber vessel.

17. The method of claim 16, wherein the step of adjusting the composition of the aqueous ammonia solvent stream comprises adding a makeup ammonia solvent stream comprising about 10 wt. % ammonia based on at least one of ammonium carbonates, ammonium bicarbonates, and ammonium carbamates.

18. The method of claim 13, further comprising operating a reboiler in communication with the desorber at a pressure of about 1 bar to about 10 bar.

19. The method of claim 18, wherein the step of heating the desorber comprises heating the reboiler to about 78 degrees C. to about 136 degrees C.
